(19) United States
(12) Patent Application Publication
(10) Pub. No.: US 2024/0109115 A1
(43) Pub. Date: Apr. 4, 2024

(54) PRESS FORMING DEVICE AND PRESS FORMING METHOD

(71) Applicant: HONDA MOTOR CO., LTD., Tokyo (JP)

(72) Inventors: Naosuke Kageyama, Tokyo (JP); Kenji Matsutani, Tokyo (JP); Susumu Egawa, Tokyo (JP); Muneyoshi Suzuki, Tokyo (JP); Tsuyomi Makino, Tokyo (JP)

(21) Appl. No.: 18/373,316

(22) Filed: Sep. 27, 2023

(30) Foreign Application Priority Data
Sep. 30, 2022 (CN) 202211209968.6

(51) Int. Cl. B21D 24/02; B21D 22/20; B30B 15/02; B30B 15/16

(52) U.S. Cl. CPC B21D 24/02; B21D 22/20; B30B 15/026; B30B 15/161

(57) ABSTRACT

In a press forming device and a press forming method for press-forming a workpiece that includes a load control region to which a constant load is to be applied, the press forming device includes a die unit that includes an upper die and a lower die that sandwich the workpiece; a slider that holds the upper die; a bolster that holds the lower die; a pressing mechanism that presses the slider toward the bolster at a plurality of pressing points; and one or more support blocks arranged around the die unit, between the bolster and the slider. The support block is arranged farther outward than the pressing points, on a line that extends, in an arrangement direction of the pressing points, from a reference point on an end portion of the load control region.

### CROSS-REFERENCE TO RELATED APPLICATIONS

This application is based upon and claims the benefit of priority from Chinese Patent Application No. 202211209968.6 filed on Sep. 30, 2022, the contents of which are incorporated herein by reference.

### BACKGROUND OF THE INVENTION

### Field of the Invention

The present invention relates to a press forming device and a press forming method.

### Description of the Related Art

Press forming involves arranging dies (a die unit) between a bolster and a slider of a press device, sandwiching a workpiece between the dies, and applying a load to form the workpiece into a predetermined shape. If the shapes of workpieces are the same, dies with the same shapes can be utilized in press devices that are used at a plurality of manufacturing sites.

### SUMMARY OF THE INVENTION

There are cases where the press device used differs depending on the manufacturing site. There are also cases where the position of a pressing point where the dies are pressed differs depending on the press device. A difference in the position of the pressing point causes a difference in the deflection amount of the dies. As a result, even when the same die unit is used, the load distribution changes depending on the press device, which causes variations among the formed products.

As an example, the outer panel of an automobile may have a ridge line with a small edge radius called a character line formed thereon. When forming such a ridge line with a small edge radius, it is necessary to apply a constant load to the entire ridge line. When the load distribution changes due to a difference in the press device, it becomes difficult to manufacture a formed product requiring a load control.

Therefore, there is a demand for a method enabling an accurate load to be applied to a prescribed location in a die unit, even in a case where the press device differs.

The present invention has the object of solving the above problem.

One aspect of the following disclosure is a press forming device for press-forming a workpiece that includes a load control region to which a constant load is to be applied, the press forming device including: a die unit that includes an upper die and a lower die configured to sandwich the workpiece; a slider configured to hold the upper die; a bolster configured to hold the lower die; a pressing mechanism configured to press the slider toward the bolster at a plurality of pressing points; and one or more support blocks arranged around the die unit, between the bolster and the slider, wherein each of the one or more support blocks is arranged farther outward than the pressing points and on a line that extends, in an arrangement direction of the pressing points, from a reference point on an end portion of the load control region.

Another aspect is a press forming method for press-forming a workpiece that includes a load control region to which a constant load is to be applied, using a press forming device, the press forming device including a die unit that includes an upper die and a lower die configured to sandwich the workpiece, a slider configured to hold the upper die, a bolster configured to hold the lower die, and a pressing mechanism configured to press the slider toward the bolster at a plurality of pressing points, the press forming method including: a step of arranging one or more support blocks around the die unit, between the bolster and the slider; and a step of forming the workpiece by pressing the support block along with the die unit, with the pressing mechanism, wherein the step of arranging the one or more support blocks includes arranging each of the one or more support blocks farther outward than the pressing points, on a line that extends, in an arrangement direction of the pressing points, from a reference point on an end portion of the load control region.

The press forming device and press forming method of the above aspects arrange the minimum number of support blocks, thereby making it possible to accurately apply a uniform load to the load control region inside the die unit, even when press devices differ. Thus, the press forming device and press forming method of the above aspects can form a workpiece that has a ridge line with a small edge radius, suitably.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1A is a side view of a press forming device according to an embodiment;

FIG. 1B is a planar view showing an arrangement relationship among a bolster, a lower die, and pressing points of the press forming device of FIG. 1A;

FIG. 2 is a flow chart showing a support block setting method according to an embodiment;

FIG. 3A is a planar view showing an arrangement relationship between the lower die and the pressing points in Example 1;

FIG. 3B is a planar view showing an arrangement relationship between the lower die and the pressing points in Example 2;

FIG. 4A is a planar view showing a basic setting example of a first support block for the load control region of Example 2 of FIG. 3B;

FIG. 4B is a planar view showing an additional setting example of a support block for Example 2 of FIG. 4A;

FIG. 5A is a planar view showing a basic setting example of a first support block and a second support block for the load control region of Example 3;

FIG. 5B is a planar view showing an additional setting example of support blocks for FIG. 5A;

FIG. 6A is a planar view showing an arrangement relationship between the lower die and the pressing points in Example 4;

FIG. 6B is a planar view showing an arrangement relationship between the lower die and the pressing points in Example 5;

FIG. 7A is a planar view showing a setting example of an imaginary rectangular shape for the lower die of Example 5 of FIG. 6B;

FIG. 7B is a planar view showing a setting example of an auxiliary block for Example 5;

FIG. 8A is a planar view showing an example in which the pressing points of the press device have an irregular arrangement;

FIG. 8B is a planar view showing a setting example of imaginary pressing points for the pressing points of FIG. 8A; and

FIG. 9 is a flow chart showing a support block setting method.

### DETAILED DESCRIPTION OF THE INVENTION

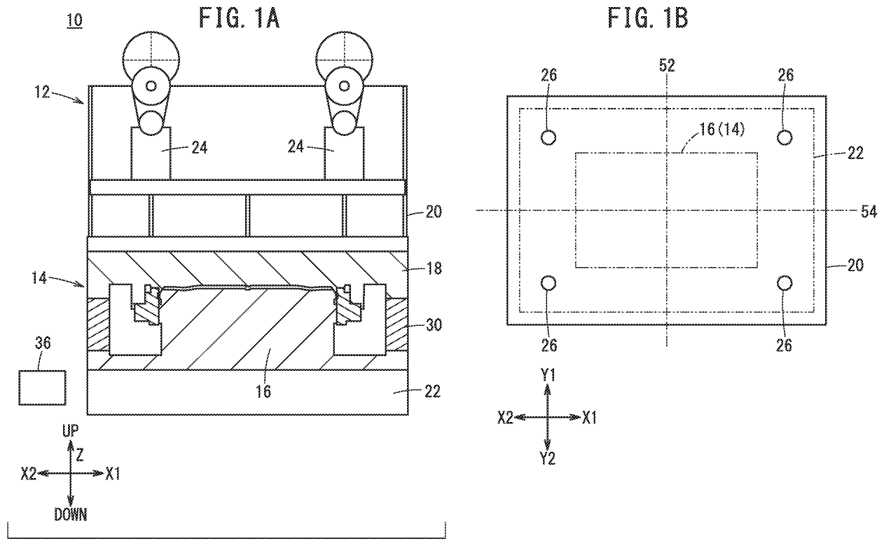

As shown in FIG. 1A, a press forming device 10 according to the present embodiment includes a press device 12 and a die unit 14. The press device 12 includes a bolster 22 that supports a lower die 16 of the die unit 14, a slider 20 that holds an upper die 18 arranged above the bolster 22, and a plurality of pressing mechanisms 24. The slider 20 is driven by the pressing mechanisms 24 to be raised and lowered. The pressing mechanisms 24 are hydraulic cylinders, for example. The pressing mechanisms 24 press the slider 20 toward the bolster 22, thereby applying a prescribed load to the die unit 14. The die unit 14 includes the lower die 16 that is held by the bolster 22 and the upper die 18 that is held by the slider 20. The die unit 14 sandwiches a workpiece, which is a forming target, between the lower die 16 and the upper die 18. The press forming device 10 applies the prescribed load to the die unit 14 with the press device 12, thereby forming the workpiece into the shape of a manufactured product.

As shown in FIG. 1B, in the press forming device 10, the die unit 14 is arranged within the range of a planar shape of the bolster 22. In the example shown in the drawing, the die unit 14 has a rectangular shape, but the die unit 14 is not limited to this. As an example, the die unit 14 for forming an outer board of a door of an automobile has the planar shape of a door. Although not specifically shown in the drawings, a guide mechanism for guiding the movement of the die unit 14 and slider 20 is arranged around the die unit 14.

The locations where the pressing mechanisms 24 press the slider 20 are shown as pressing points 26 in the drawings. Four pressing mechanisms 24 are arranged in a normal press device 12. In such a case, there are four pressing points 26. The pressing points 26 are arranged near the four corners of the rectangular slider 20, and are aligned in the transverse direction and longitudinal direction of the slider 20. In the following description, the longitudinal direction of the slider 20 is also referred to as the X direction, the transverse direction of the slider 20 is also referred to as the Y direction, and the up-down direction is also referred to as the Z direction.

In the example of FIG. 1B, the pressing points 26 are arranged at the outer sides of the die unit 14 in the X direction and Y direction. Therefore, the press device 12 causes deflection in the slider 20 and the die unit 14. The deflection is a change in the gap between the bolster 22 and the slider 20 extending in the X direction and Y direction. The deflection occurring in portions of the bolster and the slider along the X direction in which the distance between the pressing points 26 is longer, is greater than the deflection occurring in portions of the bolster and the slider along the Y direction. The deflection occurring in the portions along the X direction will be focused on. The deflection occurring in the portions along the X direction appears as deformation that causes the distance between the bolster 22 and the slider 20 in the vicinity of the end portions in the X direction to become relatively smaller and causes the distance between the bolster 22 and the slider 20 near the center in the X-direction to become relatively larger. The die unit 14 also deforms and deflects in a manner to follow the deformation of the bolster 22 and slider 20. As a result, it becomes more difficult to apply a load near the center of the die unit 14 in the X-direction, and a greater load is applied to both end portions of the die unit 14 in the X-direction.

When the press device 12 is changed, the positions of the pressing points 26 change, and therefore the manner in which the deflection appears also changes. Accordingly, there is a desire to suppress the deflection in a load control region 28, which is a region, in the die unit 14, where there is a desire for a uniform load to be applied, even when the press device 12 has been changed.

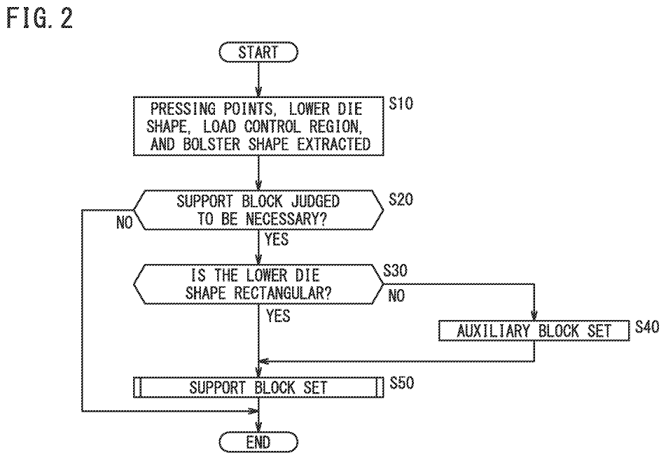

As such, as shown in FIG. 1A, the press forming device 10 of the present embodiment includes a support block 30 arranged around the die unit 14. The support block 30 is arranged farther outward than the pressing points 26. The support block 30 is set in consideration of the moment applied to the load control region 28 of the die unit 14. As described in detail further below, at least one support block 30 is arranged at a position shifted outward in the X direction from a pressing point 26, while maintaining a center position in the Y direction at the X-direction end portion of the load control region 28. In order to assist with the setting of the arrangement position of the support block 30, the press forming device 10 may include a calculator 36. By performing the process shown in FIG. 2, the calculator 36 calculates a suitable arrangement position for the support block 30. FIG. 1A shows a configuration in which the support block 30 is provided to the lower die 16, but the present embodiment is not limited to this. As an example, the support block 30 may be arranged on the bolster 22 instead of the lower die 16.

The following describes a setting method for the support block 30.

First, at step S10 of FIG. 2, the calculator 36 reads the position coordinates of the pressing points 26 of the press device 12, shape data of the lower die 16, shape data of the load control region 28, and shape data of the bolster 22.

At step S20, the calculator 36 makes a judgment about whether a support block 30 is necessary. The judgment concerning the necessity of the support block 30 is performed based on a positional relationship between the lower die 16 of the die unit 14 and the pressing point 26. The deflection occurs centered at the center between the pressing points 26 in the longitudinal direction. Therefore, in the present embodiment, a center line 52 indicating the center in the X direction between the four pressing points 26 is set, and the necessity judgment is performed for each of a region in the X1 direction from the center line 52 and a region in the X2 direction from the center line 52. In the following description of processing, the region on the X1-direction side is used as an example. A description of the processing for the region on the X2-direction side is the basically the same as the processing for the region on the X1-direction side, aside from having right-left symmetry, and is therefore omitted.

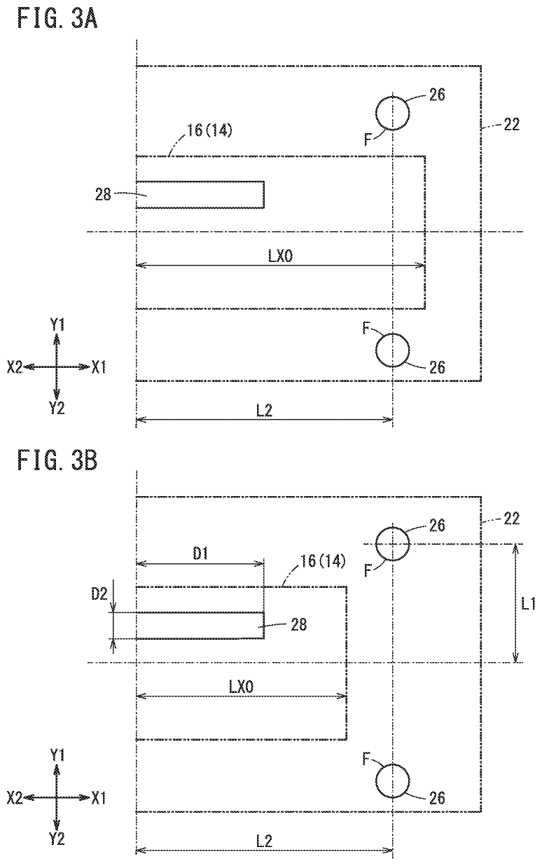

If, in the region on the X1-direction side, the pressing points 26 are positioned farther inward than the X1-direction end portion of the lower die 16 and are close to an intermediate line, the calculator 36 judges that a support block 30 is unnecessary (step S20: NO). As an example, in the case of Example 1 in FIG. 3A, the lower die 16 extends outward beyond the two pressing points 26 in the X1 direction. In Example 1, the X-direction positions of the two pressing points 26 are farther inward than the X1-direction end portion of the lower die 16 (LX0>L2). In such a case, the slider 20 and the die unit 14 barely experience deflection. Accordingly, in the case of FIG. 3A, the calculator 36 judges that a support block 30 is unnecessary (step S20: NO), and ends the processing.

As another example, in the case of Example 2 in FIG. 3B, the X-direction dimension of the lower die 16 is shorter than in Example 1. The X1-direction end portion of the lower die 16 is positioned farther inward than the pressing points 26 (LX0<L2). Accordingly, in the case of Example 2 of FIG. 3B, the calculator 36 judges that a support block 30 is necessary (step S20: YES).

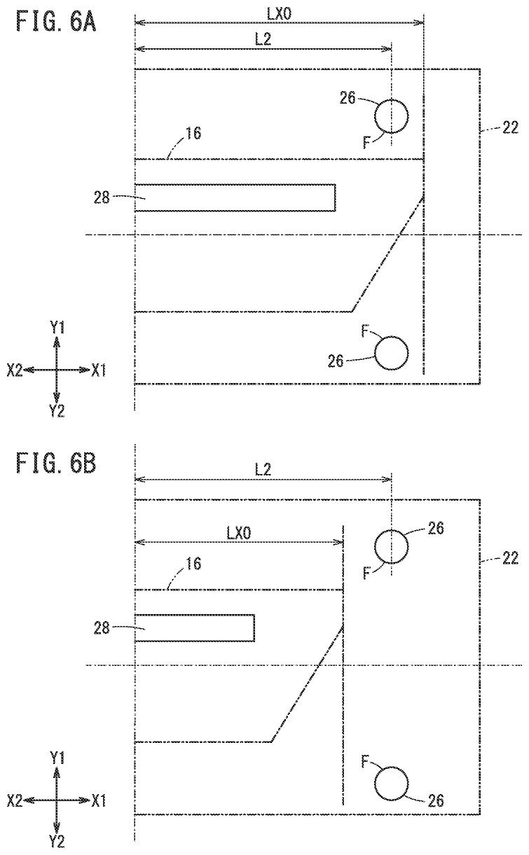

Step S20 is performed in the same manner even in a case where the shape of the lower die 16 is not a rectangle. For example, the lower dies 16 of Example 4 and Example 5 shown in FIGS. 6A and 6B are boat-shaped instead of rectangular. The X1-direction end portion of the lower die 16 of Example 4 is positioned farther outward than the pressing points 26 (LX0>L2). Accordingly, in the case of Example 4 of FIG. 6A, the pressing points 26 are positioned farther inward than the end portion of the lower die 16, and so the calculator 36 judges that a support block 30 is unnecessary (step S20: NO) and ends the processing.

The lower die 16 of Example 5 shown in FIG. 6B is boat-shaped and not rectangular. The X1-direction end portion of the lower die 16 of Example 5 is positioned farther inward than the pressing points 26 (LX0<L2). Accordingly, in the case of Example 5 of FIG. 6B, the pressing points 26 are positioned farther outward than the end portion of the lower die 16, and so the calculator 36 judges that a support block 30 is necessary (step S20: YES).

In a case where the calculator 36 makes a judgement of “YES” in step S20, the process moves to step S30.

At step S30, the calculator 36 judges whether the shape of the lower die 16 is a rectangle. If it is judged that the lower die 16 is not rectangular (step S30: NO), the process moves to step S40. If it is judged that the lower die 16 is rectangular (step S30: YES), the process moves to step S50.

As examples, the lower dies 16 shown in FIGS. 3B to 5B (Examples 1 to 3) have rectangular shapes. Accordingly, in the cases of Examples 1 to 3, the calculator 36 judges that the shape is a rectangle (step S30: YES). If the calculator 36 makes a judgment of “YES” in step S30, the process moves to step S50.

As another example, the shape of the lower die 16 shown in FIG. 6B (Example 5) is not rectangular. Accordingly, for Example 5, the calculator 36 judges that the shape is not a rectangle (step S30: NO). If the calculator 36 makes a judgment of “NO” in step S30, the process moves to step S40 of FIG. 2.

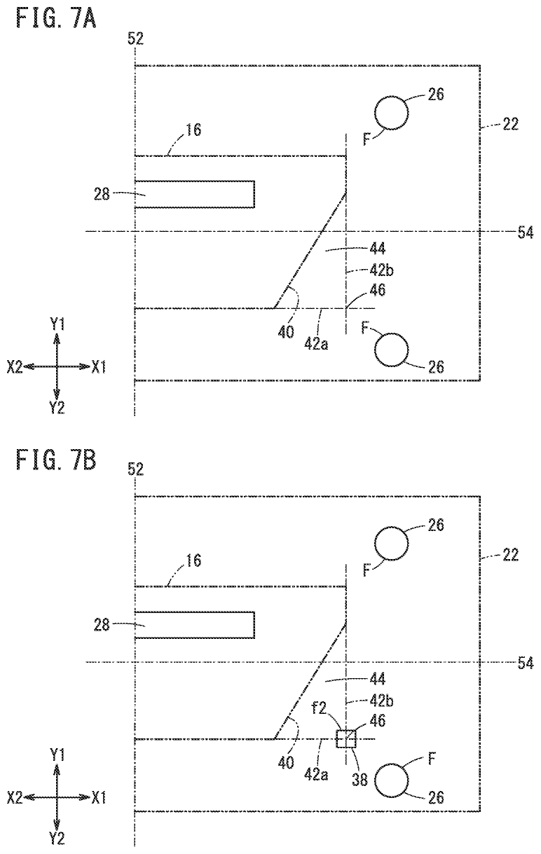

At step S40 of FIG. 2, the calculator 36 performs a setting process for an auxiliary block 38. The auxiliary block 38 is a support member arranged near the lower die 16. The auxiliary block 38 adjusts the load distribution around the lower die 16 that is not rectangular, so that the lower die 16 can be treated as rectangular. As an example, in the case of Example 5 of FIG. 7A, the lower die 16 has a shape obtained by cutting away one corner from a rectangle. In this case, the calculator 36 draws two imaginary lines 42a and 42b that are orthogonal to each other, the imaginary lines being obtained by extending two edges of the lower die adjacent to the cut-away portion 40, and obtains an intersection point between these imaginary lines 42a and 42b as a corner 46 of an imaginary rectangular shape 44. After this, as shown in FIG. 7B, the calculator 36 sets the auxiliary block 38 at the corner 46. The lower die 16 for which the auxiliary block 38 has been set has a load distribution equivalent to that of a lower die 16 having a rectangular shape corresponding to the imaginary rectangular shape, and therefore can be treated as a rectangular lower die 16. After this, the process moves to step S50 while treating the lower die 16 as a lower die 16 having the imaginary rectangular shape 44.

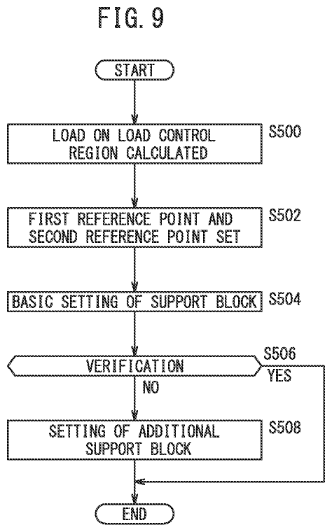

At step S50, the calculator 36 disposes the support block 30. Step S50 is a process in which the calculator 36 realizes an arrangement position for the support block 30 making it possible to suppress variation in the load of the load control region 28. First, at step S500 of FIG. 9, the calculator 36 calculates a load f1 applied to the load control region 28. The load f1 is calculated as the product of an ideal surface pressure σh (kgf/mm²) occurring when the load is applied to the workpiece and the surface area S of the load control region 28.

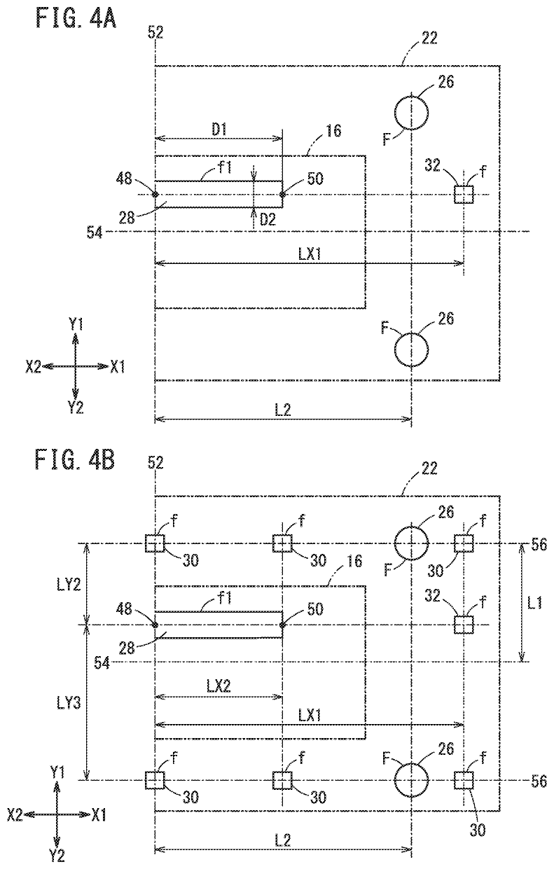

As an example, in the case of Example 2 shown in FIG. 4A, the load control region 28 has a rectangular shape with an X-direction dimension of D1 and a Y-direction dimension of D2. Accordingly, the load of the load control region 28 in Example 2 is calculated as f1=σh×D1×D2.

Next, at step S502 of FIG. 9, the calculator 36 sets a first reference point 48 and a second reference point 50. In a case where the load control region 28 extends traversing the center line 52 indicating the X-direction center of the slider 20, the first reference point 48 is obtained as the Y-direction center of a line segment of the center line 52 delimited by the load control region 28. Furthermore, in a case where the load control region 28 does not traverse the center line 52, the first reference point 48 is set at an end portion closest to the center line 52 in the load control region 28. The first reference point 48 is a location, in the load control region 28, that is distanced farthest in the X direction from the pressing point 26 on the X1-direction side, and thus the first reference point is a portion that receives the largest moment from the pressing point 26. The second reference point 50 is obtained as the Y-direction center of the outer (i.e., a side distanced from the center line 52) end portion of the load control region 28.

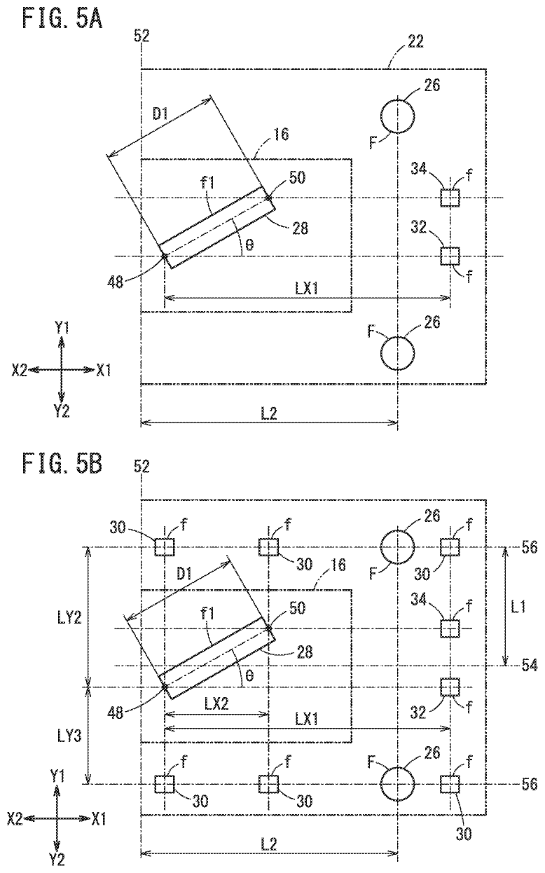

Next, the process moves to step S504. At step S504, the calculator 36 performs a basic setting of the support block 30. In step S504, if the Y-direction positions of the first reference point 48 and the second reference point 50 are the same (see FIG. 4A), the calculator 36 obtains an arrangement position of only a first support block 32. If the Y-direction positions of the first reference point 48 and the second reference point 50 are different (see FIG. 5A), the calculator 36 obtains arrangement positions of the first support block 32 and a second support block 34.

The first support block 32 is set on a straight line extending in the X direction through the first reference point 48. That is, the first support block 32 is set at the same Y-direction position as the first reference point 48. Furthermore, the X-direction position of the first support block 32 is arranged at a position where the moment M1 of the pressing points 26 is balanced with respect to the first reference point 48. The moment M1 is the moment acting on the first reference point 48 centered on the Y-direction axis connecting the two pressing points 26. The first support block 32 is set in a manner to satisfy a condition that the moment M1 becomes 0.

Specifically, the load from each pressing point 26 is F and the load applied to the first support block 32 is f. Furthermore, the X-direction distance between the pressing point 26 and the first reference point 48 is L2 and the distance between the first support block 32 and the first reference point 48 is LX1. The load applied to the load control region 28 is f1, and an angle between the center line of the load control region 28 and the X direction is θ. In such a case, the moment M1 with respect to the first reference point 48 is expressed as shown in the equation below.

M1=2F×L2−(f1×D1×cos θ)−(f×LX1)

In order to suppress the deflection, the moment M1 with respect to the first reference point 48 should be 0, and therefore the position of the first support block 32 is obtained by solving for LX1 in the above equation with the left side of the equation set to 0.

In the case of Example 2 shown in FIG. 4A, the angle θ between the center line of the load control region 28 and the X direction is 0° and cos θ is 1. As a result, the first support block 32 is set at the position shown in the drawing. Furthermore, in the case of Example 3 shown in FIG. 5A, the first support block 32 is arranged at the position shown in the drawing.

In a case where the Y-direction position of the second reference point 50 and the Y-direction position of the first reference point 48 differ, the calculator 36 obtains the arrangement position of the second support block 34 as well. The position of the second support block 34 is obtained based on the positions of the second reference point 50 and the first support block 32. Specifically, an intersection point between a straight line extending in the X direction through the second reference point 50 and a straight line extending in the Y direction through the first support block 32 is obtained as the arrangement position of the second support block 34.

Next, the process moves to step S506. At step S506, the calculator 36 performs a verification of the support block 30 obtained in step S504. The calculator 36 obtains a breaking limit force fa obtained by multiplying the cross-sectional area Sa of the support block 30 by the tensile strength Ga of the material. Then, if the load f applied to the first support block 32 (and second support block 34) exceeds the breaking limit force fa, this means that the strength of just the first support block 32 (and second support block 34) is insufficient, and so the process moves to step S508 to set an additional support block 30.

Furthermore, at step S506, the calculator 36 judges whether the arrangement position of the support block 30 obtained in step S504 is not beyond the X-direction end portion of the bolster 22. If the arrangement position of this block is beyond the X-direction end portion of the bolster 22, the moment cannot be cancelled out by only the first support block 32 (and second support block 34). Therefore, the process moves to step S508 to set an additional support block 30.

On the other hand, at step S506, if the calculator 36 has judged that the first support block 32 (and second support block 34) fulfills the above condition (step S506: YES), the process ends.

At step S508, the calculator 36 performs the setting of the additional support block 30. The calculator 36 obtains an additional setting line 56 that extends in the X direction and passes through the pressing point 26, as shown in FIG. 5B. Next, the calculator 36 sets an additional support block 30 at each of an intersection point between the additional setting line 56 and a line extending in the Y direction through the first reference point 48, an intersection point between the additional setting line 56 and a line extending in the Y direction through the second reference point 50, and an intersection point between the additional setting line 56 and a line extending in the Y direction through the first support block 32. In this case, in order to balance the moment with respect to an X-direction axial line passing through the first reference point 48, an additional support block 30 is added at each Y-direction end (Y1 direction and Y2 direction) of the load control region 28. Specifically, the calculator 36 obtains an additional setting line 56 for each of the two pressing points 26 separated from each other in the Y direction, and sets support blocks 30 along each of the additional setting lines 56.

After this, the positions of the support blocks 30 are obtained again such that the moment Mx and the moment My with respect to the first reference point 48 are each balanced. For example, in the case of Example 2 in FIG. 4B, the positions of the support blocks 30 are obtained from a condition satisfying the equations below.

Mx=2F×L2−f1×LX2−f×(3LX1+2LX2)=0

My=LY2×(F+3f)−LY3×(F+3f)=0

2×L1=LY2+LY3

Here, LX2 is the X-direction distance between the first reference point 48 and the second reference point 50. LY2 is the Y-direction distance between the first reference point 48 and the additional setting line 56 on the Y1-direction side. LY3 is the Y-direction distance between the first reference point 48 and the additional setting line 56 on the Y2-direction side. L1 is a half-value of the Y-direction dimension of the rectangular region.

As another example, in the case of Example 3 of FIG. 5B, the positions of the support blocks 30 are obtained from a condition satisfying the equations below.

Mx=2F×L2−f1×D1×cos θ−f×(4LX1+2LX2)=0

My=LY2×(F+4f)+f1×D1×sin θ−LY3×(F+3f)=0

2×L1=LY2+LY3

As a result of step S508, in the case of Example 2 of FIG. 4B, a first support block 32 and six additional support blocks 30 are set. Furthermore, in the case of Example 3 of FIG. 5B, a first support block 32, a second support block 34, and six additional support blocks 30 are set.

After the above, the setting process for the support block 30 ends.

Next, the press forming device 10 arranges the first support block 32, the second support block 34 (if necessary), and additional support blocks 30 (if necessary) between the slider 20 and the bolster 22, and performs the press-forming on the workpiece using the die unit 14. The press forming method using the press forming device 10 of the present embodiment makes it possible to apply a uniform load to the load control region 28 by suppressing the deflection of the load control region 28.

### (Modifications of the Embodiments)

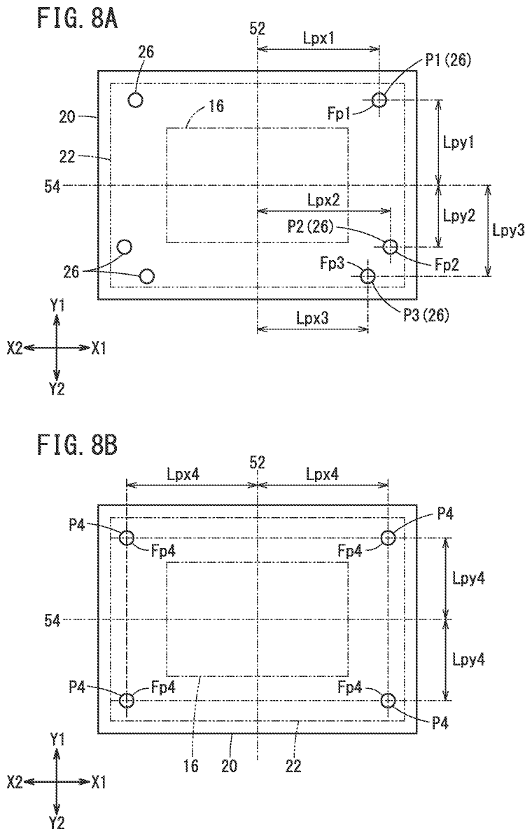

In the examples described above, the pressing points 26 are arranged at the corner portions 46 of a rectangular region in the press device 12, but the embodiments are not limited to this. As an example, in a case where the pressing points 26 are arranged irregularly such as shown in FIG. 8A, it is possible to perform the support block 30 setting process (step S50) of FIG. 2 by setting four virtual pressing points P4 such as shown in FIG. 8B.

The following describes a setting method for virtual pressing points P4 in a case where the pressing points 26 are arranged irregularly, in the example of FIG. 8A. In the following description, a portion of the press device 12 from the center in the X direction toward the X1-direction side is shown, but the portion from the X-direction center toward the X2-direction side is the same, aside from having left-right symmetry.

In the example shown in the drawing, three pressing points P1, P2, and P3 are included in the X1-direction side region. In the present modification, the setting of two virtual pressing points P4 is performed based on the loads of the three pressing points P1, P2, and P3. Here, the loads of the pressing points P1, P2, and P3 are denoted by respectively Fp1, Fp2, and Fp3. By adding together the loads Fp1, Fp2, and Fp3 and dividing the result by 2, the load Fp4 of each of the virtual pressing points P4 is obtained.

Fp4=(Fp1+Fp2+Fp3)/2

Next, based on the moment with reference to the center line 52 indicating the X-direction center of the slider 20 and the moment with reference to the center line 54 indicating the Y-direction center of the slider 20, the X-direction distances between the center line 52 indicating the X-direction center of the slider 20 and the respective pressing points P1, P2, and P3 are respectively Lpx1, Lpx2, and Lpx3. The X-direction distance Lpx4 from the center line 52 indicating the X-direction center to the virtual pressing point P4 is obtained from the equation below.

Lpx4=(Fp1×Lpx1+Fp2×Lpx2+Fp3×Lpx3)/(2×Fp4)

The Y-direction distances between the center line 54 indicating the Y-direction center of the slider 20 and the respective pressing points P1, P2, and P3 are respectively Lpy1, Lpy2, and Lpy3. The Y-direction distance Lpy4 from the center line 54 indicating the Y-direction center to the virtual pressing point P4 is obtained from the equation below.

Lpy4=(Fp1×Lpy1+Fp2×Lpy2+Fp3×Lpy3)/(2×Fp4)

As shown in FIG. 8B, the virtual pressing points P4 are set respectively at a position distanced Lpy4 in the Y1 direction from the center line 54 indicating the Y-direction center and a position distanced Lpy4 in the Y2 direction from the center line 54 indicating the Y-direction center.

By using the virtual pressing points P4 set in the manner described above, it is possible to set a support block 30 with the process shown in FIG. 2.

The above disclosure is summarized as shown below.

One aspect is a press forming device (10) for press-forming a workpiece that includes the load control region (28) to which a constant load is to be applied, the press forming device including: the die unit (14) that includes the upper die (18) and the lower die (16) that sandwich the workpiece; the slider (20) that holds the upper die; the bolster (22) that holds the lower die; the pressing mechanism (24) that presses the slider toward the bolster, at the plurality of pressing points (26); and the one or more support blocks (30) arranged around the die unit, between the bolster and the slider, wherein the support block is arranged farther outward than the pressing points, on a line that extends, in the arrangement direction of the pressing points, from the reference point on the end portion of the load control region.

According to the press forming device described above, a uniform load can be applied to the load control region by suppressing the deflection of the load control region, and therefore it is possible to increase the machining accuracy in the load control region. Accordingly, the press forming device described above can accurately form a formed product containing a ridge line or the like forming a character line for which uniform load application is desired.

In the press forming device described above, the pressing points may be arranged at four corners of a rectangular region; and at least one of the one or more support blocks may be arranged on a line extending in the longitudinal direction of the rectangular region from the first reference point (48), which is set at a portion, of the load control region, that intersects the center line (52) indicating the center in the longitudinal direction or at the end portion, of the load control region, that is closest to the center line. This press forming device can minimize the number of support blocks that are arranged, and therefore the configuration of the device can be simplified and the number of steps in preparation work can be reduced.

In the press forming device described above, the load control region may extend in the longitudinal direction; and the one or more support blocks may include the first support block (32) that is arranged on a line extending in the longitudinal direction from the first reference point. This press forming device can minimize the number of support blocks that are arranged, and therefore the number of steps in preparation work can be reduced.

In the press forming device described above, the load control region may extend in an inclined manner relative to the longitudinal direction; and the one or more support blocks may include: the first support block arranged on a line extending in the longitudinal direction from the first reference point; and the second support block (34) arranged on a line extending in the longitudinal direction from the second reference point (50), which is set at the end portion, in the load control region, that is farthest from the center line. With this press forming device, even if the load control region is inclined, a uniform load can be applied to the load control region.

In the press forming device described above, there may be additional support blocks, which are arranged respectively: on a line extending in a transverse direction of the rectangular region from the first reference point; on a line extending in the transverse direction from the second reference point, which is set at the end portion, of the load control region, that is farthest from the center line; and on a line extending in the transverse direction from the first support block. This press forming device spreads the load among a plurality of support blocks, thereby preventing breakage of the support blocks and reliably preventing deflection of the load control region, making it possible to apply a uniform load to the load control region.

In the press forming device described above, the lower die may have a non-rectangular shape obtained by cutting away a portion of a rectangle; and the auxiliary block (38) may be arranged at a corner (46) of an imaginary rectangular shape obtained by filling in the portion of the rectangle, in the lower die, that was cut away. This press forming device makes it possible to treat a non-rectangular lower die as a rectangular lower die, making it easier to arrange the support blocks.

Another aspect is a press forming method for press-forming a workpiece that includes a load control region to which a constant load is to be applied, using a press forming device, the press forming device including a die unit that includes an upper die and a lower die that sandwich the workpiece, a slider that holds the upper die, a bolster that holds the lower die, and a pressing mechanism that presses the slider toward the bolster at a plurality of pressing points, the press forming method including: a step (S50) of arranging one or more support blocks around the die unit, between the bolster and the slider; and a step of forming the workpiece by pressing the support block along with the die unit, with the pressing mechanism, wherein the step of arranging the one or more support blocks includes arranging the support block farther outward than the pressing points, on a line that extends, in an arrangement direction of the pressing points, from a reference point on an end portion of the load control region.

In the press forming method above, the pressing points may be arranged at four corners of a rectangular region; and at least one of the one or more support blocks may be arranged on a line extending in a longitudinal direction of the rectangular region from the first reference point, which is set at the portion, of the load control region, that intersects the center line indicating the center in the longitudinal direction or at the end portion, of the load control region, that is closest to the center line.

In the press forming method described above, the load control region may extend in the longitudinal direction; and the one or more support blocks may include the first support block that is arranged on a line extending in the longitudinal direction from the first reference point.

In the press forming method described above, the load control region may extend in an inclined manner relative to the longitudinal direction; and the one or more support blocks may include: the first support block arranged on a line extending in the longitudinal direction from the first reference point; and the second support block arranged on a line extending in the longitudinal direction from the second reference point, which is set at an end portion, of the load control region, that is farthest from the center line.

In the press forming method described above, there may be additional support blocks, which are arranged respectively: on a line extending in the transverse direction of the rectangular region from the first reference point; on a line extending in the transverse direction from the second reference point, which is set at the end portion, of the load control region, that is farthest from the center line; and on a line extending in the transverse direction from the first support block.

In the press forming method described above, the lower die may have a non-rectangular shape obtained by cutting away a portion of a rectangle; and the auxiliary block may be arranged at a corner of an imaginary rectangular shape obtained by filling in the portion of the rectangle, in the lower die, that was cut away.

The present invention is not limited to the above disclosure, and various configuration can be adopted without deviating from the scope and gist of the present invention.

What is claimed is:

1. A press forming device for press-forming a workpiece that includes a load control region to which a constant load is to be applied, the press forming device comprising:
a die unit that includes an upper die and a lower die configured to sandwich the workpiece;
a slider configured to hold the upper die;
a bolster configured to hold the lower die;
a pressing mechanism configured to press the slider toward the bolster at a plurality of pressing points; and
one or more support blocks arranged around the die unit and between the bolster and the slider, wherein:
each of the one or more support blocks is arranged farther outward than the pressing points and on a line that extends, in an arrangement direction of the pressing points, from a reference point on an end portion of the load control region.

2. The press forming device according to claim 1, wherein:
the pressing points are arranged at four corners of a rectangular region; and
at least one of the one or more support blocks is arranged on a line extending in a longitudinal direction of the rectangular region from a first reference point, the first reference point being set at a portion, of the load control region, that intersects a center line indicating a center in the longitudinal direction or at an end portion, of the load control region, that is closest to the center line.

3. The press forming device according to claim 2, wherein:
the load control region extends in the longitudinal direction; and
the one or more support blocks include a first support block that is arranged on a line extending in the longitudinal direction from the first reference point.

4. The press forming device according to claim 2, wherein:
the load control region extends in an inclined manner relative to the longitudinal direction; and
the one or more support blocks include:
a first support block arranged on a line extending in the longitudinal direction from the first reference point; and
a second support block arranged on a line extending in the longitudinal direction from a second reference point, the second reference point being set at an end portion, of the load control region, that is farthest from the center line.

5. The press forming device according to claim 3, further comprising additional support blocks, which are arranged respectively:
on a line extending in a transverse direction of the rectangular region from the first reference point;
on a line extending in the transverse direction from a second reference point, the second reference point being set at an end portion, of the load control region, that is farthest from the center line; and
on a line extending in the transverse direction from the first support block.

6. The press forming device according to claim 1, wherein:
the lower die has a non-rectangular shape obtained by cutting away a portion of a rectangle; and
an auxiliary block is arranged at a corner of an imaginary rectangular shape obtained by filling in the portion of the rectangle, in the lower die, that was cut away.

7. A press forming method for press-forming a workpiece that includes a load control region to which a constant load is to be applied, using a press forming device, the press forming device including a die unit that includes an upper die and a lower die configured to sandwich the workpiece, a slider configured to hold the upper die, a bolster configured to hold the lower die, and a pressing mechanism configured to press the slider toward the bolster at a plurality of pressing points, the press forming method comprising:
arranging one or more support blocks around the die unit, between the bolster and the slider; and
forming the workpiece by pressing the support block along with the die unit, with the pressing mechanism, wherein:
the arranging of the one or more support blocks includes arranging each of the one or more support blocks farther outward than the pressing points, on a line that extends, in an arrangement direction of the pressing points, from a reference point on an end portion of the load control region.

8. The press forming method according to claim 7, wherein:
the pressing points are arranged at four corners of a rectangular region; and
at least one of the one or more support blocks is arranged on a line extending in a longitudinal direction of the rectangular region from a first reference point, the first reference point being set at a portion, of the load control region, that intersects a center line indicating a center in the longitudinal direction or at an end portion, of the load control region, that is closest to the center line.

9. The press forming method according to claim 8, wherein:
the load control region extends in the longitudinal direction; and
the one or more support blocks include a first support block that is arranged on a line extending in the longitudinal direction from the first reference point.

10. The press forming method according to claim 8, wherein:
the load control region extends in an inclined manner relative to the longitudinal direction; and
the one or more support blocks include:
a first support block arranged on a line extending in the longitudinal direction from the first reference point; and
a second support block arranged on a line extending in the longitudinal direction from a second reference point, the second reference point being set at an end portion, of the load control region, that is farthest from the center line.

11. The press forming method according to claim 9, wherein:
additional support blocks are arranged respectively:
on a line extending in a transverse direction of the rectangular region from the first reference point;
on a line extending in the transverse direction from a second reference point, the second reference point being set at an end portion, of the load control region, that is farthest from the center line; and
on a line extending in the transverse direction from the first support block.

12. The press forming method according to claim 7, wherein:
the lower die has a non-rectangular shape obtained by cutting away a portion of a rectangle; and
an auxiliary block is arranged at a corner of an imaginary rectangular shape obtained by filling in the portion of the rectangle, in the lower die, that was cut away.
